(19) United States
(12) Patent Application Publication
(10) Pub. No.: US 2006/0129992 A1
(43) Pub. Date: Jun. 15, 2006

(54) Software test and performance monitoring system

(76) Inventors: Brian K. Oberholtzer, Glenmoore, PA (US); Michael Lutz, Wayne, PA (US)

Correspondence Address: Siemens Corporation;Intellectual Property Department, 170 Wood Avenue South, Iselin, NJ, 08830, US

(21) Appl. No.: 11/271,249

(22) Filed: Nov. 10, 2005

Related U.S. Application Data
(60) Provisional application No. 60/626,781, filed on Nov. 10, 2004.

(51) Int. Cl. G06F 9/44

(52) U.S. Cl. 717/124

(57) ABSTRACT

A quality assurance benchmark system tests a target executable application under load stress conditions over an extended period of time. The system has user-controlled parameters to benchmark performance, scalability, and regression testing before deploying the application to customers. The system includes a display processor and a test unit. The display processor generates data representing a display image enabling a user to select: input parameters to be provided to the target executable application, and output data items to be received from the target executable application and associated expected range values of the data items. The test unit provides multiple concurrently operating executable procedures for interfacing with the target executable application to provide the input parameters to the target executable application, and to determine whether data items received from the target executable application are within corresponding associated expected range values of the data items.

### CROSS-REFERENCE TO RELATED APPLICATIONS

The present application is a non-provisional application of provisional application having Ser. No. 60,626,781 filed by Brian K. Oberholtzer, et al. on Nov. 10, 2004.

### FIELD OF THE INVENTION

The present invention generally relates to computers. More particularly, the present invention relates to a software test and performance monitoring system for software applications.

### BACKGROUND OF THE INVENTION

A computer is a device or machine for processing information from data according to a software program, which is a compiled list of instructions. The information to be processed may represent numbers, text, pictures, or sound, amongst many other types.

Software testing is a process used to help identify the correctness, completeness, and quality of a developed software program. Common quality attributes include reliability, stability, portability, maintainability, and usability.

Prior software testing uses single purpose tools, such as LoadRunner® load test software, for load testing user interfaces. Such single purpose tools do not provide an integrated test environment. Further, prior testing methods are limited in their ability to perform concurrent testing of multiple test conditions in the same test.

Some developers wait until an application is fully built to quality assure the system. That approach allows potential inefficiencies and flaws to remain inside the core components.

Prior systems often require building a single use or disposable end-to-end system. Current software development practices often use one-off programs, tailor-written for stress testing, or interface to commercial packages that also require tailoring a test environment.

In the absence of a system performance and reliability testing framework, developers often write their own tests from scratch, which is a wasteful process and prone to errors as the developers may not include necessary test scenarios to adequately quality assure the code. Frequently, developers skip this type of testing, which leads to quality crises in early deployments. Accordingly, there is a need for a software test and performance monitoring system for software applications that overcomes these and other disadvantages of the prior systems.

### SUMMARY OF THE INVENTION

A system for testing an executable application comprises a display processor and a test unit. The display processor generates data representing a display image enabling a user to select: input parameters to be provided to a target executable application, and output data items to be received from the target executable application and associated expected range values of the data items. The test unit provides multiple concurrently operating executable procedures for interfacing with the target executable application to provide the input parameters to the target executable application, and to determine whether data items received from the target executable application are within corresponding associated expected range values of the output data items.

### BRIEF DESCRIPTION OF THE DRAWINGS

FIG. 1 illustrates a system, in accordance with invention principles.

FIG. 2 illustrates a test engine interface for the system, as shown in FIG. 1, in accordance with invention principles.

FIG. 3 illustrates test suite configuration settings for the test engine interface, as shown in FIG. 2, in accordance with invention principles.

FIG. 4 illustrates advanced test configuration settings for the test suite configuration settings, as shown in FIG. 3, in accordance with invention principles.

FIG. 5 illustrates test configuration logging options for the test engine interface, as shown in FIG. 2, in accordance with invention principles.

FIG. 6 illustrates a test interface for a plug-in, in accordance with invention principles.

FIG. 7 illustrates an optional test interface for a plug-in, in accordance with invention principles.

FIG. 8 illustrates plug-in registry entries, in accordance with invention principles.

FIG. 9 illustrates a method for configuring a test module, in accordance with invention principles.

FIG. 10 illustrates a test engine storage structure, in accordance with invention principles.

FIG. 11 illustrates a test engine, in accordance with invention principles.

FIG. 12 illustrates a process of interaction between the test engine and the test modules, in accordance with invention principles.

FIG. 13 illustrates a plug-in display link library interface, in accordance with invention principles.

FIG. 14 illustrates an ALT COM Object Interface, in accordance with invention principles.

FIG. 15 illustrates a new project interface, in accordance with invention principles.

FIG. 16 illustrates a test plug-in interface, in accordance with invention principles.

FIG. 17 illustrates an ALT object wizard interface, in accordance with invention principles.

FIG. 18 illustrates an ALT object wizard properties interface, in accordance with invention principles.

FIG. 19 illustrates a class display interface, in accordance with invention principles.

FIG. 20 illustrates a test plug-in interface, in accordance with invention principles.

FIG. 21 illustrates a warning interface, in accordance with invention principles.

FIG. 22 illustrates a browse type libraries interface, in accordance with invention principles.

FIG. 23 illustrates an implement interface, in accordance with invention principles.

FIG. 24 illustrates a test registration interface, in accordance with invention principles.

### DETAILED DESCRIPTION OF THE PREFERRED EMBODIMENTS

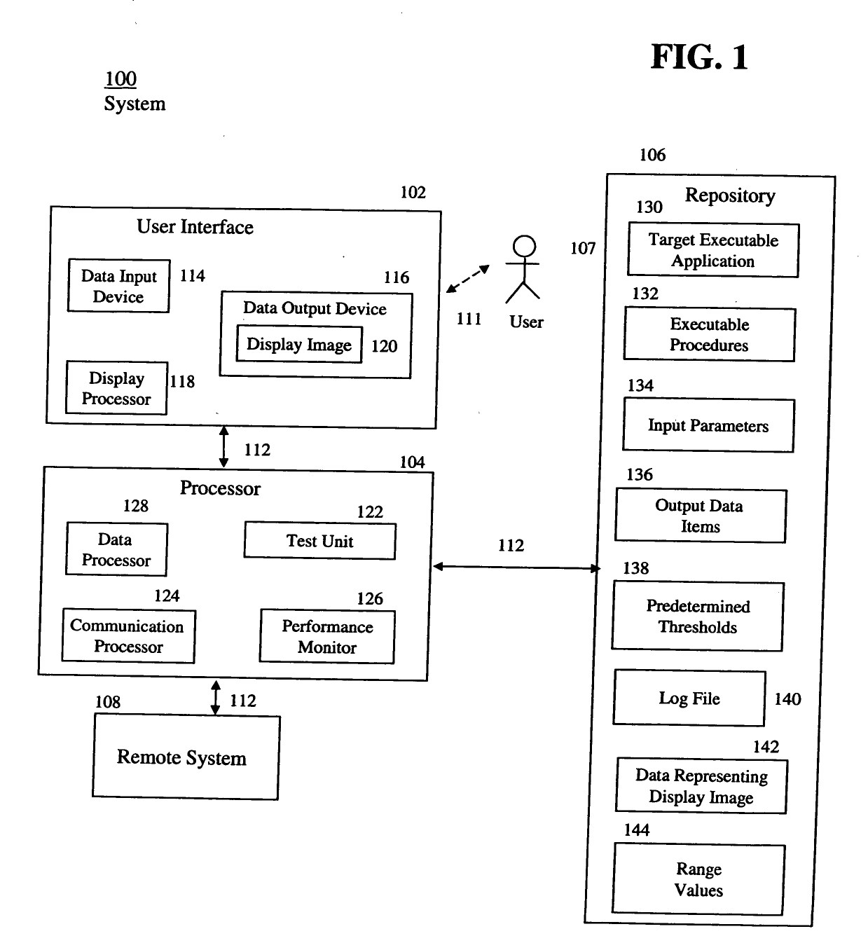

FIG. 1 illustrates a software test and performance monitoring system (i.e., “system”). The system 100 includes a user interface 102, a processor 104, and a repository 106. A remote system 108 and a user 107 interacts with the system 100.

A communication path 112 interconnects elements of the system 100, and/or interconnects the system 100 with the remote system 108. The dotted line near reference number 111 represents interaction between the user 107 and the user interface 102.

The user interface 102 further provides a data input device 114, a data output device 116, and a display processor 118. The data output device 116 further provides one or more display images 120.

The processor 104 further includes a test unit 122, a communication processor 124, a performance monitor (processor) 126, and a data processor 128.

The repository 106 further includes a target executable application 130, executable procedures 132, input parameters 134, output data items 136, predetermined thresholds 138, a log file 140, data representing display images 142, and range values 144.

The system 100 may be employed by any type of enterprise, organization, or department, such as, for example, providers of healthcare products and/or services responsible for servicing the health and/or welfare of people in its care. The system 100 may be fixed and/or mobile (i.e., portable), and may be implemented in a variety of forms including, but not limited to, one or more of the following: a personal computer (PC), a desktop computer, a laptop computer, a workstation, a minicomputer, a mainframe, a supercomputer, a network-based device, a personal digital assistant (PDA), a smart card, a cellular telephone, a pager, and a wristwatch. The system 100 and/or elements contained therein also may be implemented in a centralized or decentralized configuration. The system 100 may be implemented as a client-server, web-based, or stand-alone configuration. In the case of the client-server or web-based configurations, the target executable application 130 may be accessed remotely over a communication network. The communication path 112 (otherwise called network, bus, link, connection, channel, etc.) represents any type of protocol or data format including, but not limited to, one or more of the following: an Internet Protocol (IP), a Transmission Control Protocol Internet protocol (TCPIP), a Hyper Text Transmission Protocol (HTTP), an RS232 protocol, an Ethernet protocol, a Medical Interface Bus (MIB) compatible protocol, a Local Area Network (LAN) protocol, a Wide Area Network (WAN) protocol, a Campus Area Network (CAN) protocol, a Metropolitan Area Network (MAN) protocol, a Home Area Network (HAN) protocol, an Institute Of Electrical And Electronic Engineers (IEEE) bus compatible protocol, a Digital and Imaging Communications (DICOM) protocol, and a Health Level Seven (HL7) protocol.

The user interface 102 permits bi-directional exchange of data between the system 100 and the user 107 of the system 100 or another electronic device, such as a computer or an application.

The data input device 114 typically provides data to a processor in response to receiving input data either manually from a user or automatically from an electronic device, such as a computer. For manual input, the data input device is a keyboard and a mouse, but also may be a touch screen, or a microphone with a voice recognition application, for example.

The data output device 116 typically provides data from a processor for use by a user or an electronic device or application. For output to a user, the data output device 116 is a display, such as, a computer monitor (e.g., a screen), that generates one or more display images 120 in response to receiving the display signals from the display processor 118, but also may be a speaker or a printer, for example.

The display processor 118 (e.g., a display generator) includes electronic circuitry or software or a combination of both for generating the display images 120 or portions thereof. The data output device 116, implemented as a display, is coupled to the display processor 118 and displays the generated display images 120. The display images 120 provide, for example, a graphical user interface, permitting user interaction with the processor 104 or other device. The display processor 118 may be implemented in the user interface 102 and/or the processor 104.

The system 100, elements, and/or processes contained therein may be implemented in hardware, software, or a combination of both, and may include one or more processors, such as processor 104. A processor is a device and/or set of machine-readable instructions for performing task. The processor includes any combination of hardware, firmware, and/or software. The processor acts upon stored and/or received information by computing, manipulating, analyzing, modifying, converting, or transmitting information for use by an executable application or procedure or an information device, and/or by routing the information to an output device. For example, the processor may use or include the capabilities of a controller or microprocessor.

Each of the test unit 122 and the performance processor 126 performs specific functions for the system 100, as explained in further detail below, with reference to FIG. 1, and in further detail, with reference to the remaining figures. The communication processor 124 manages communication within the system 100 and outside the system 100, such as, for example, with the remote system 108. The data processor 128 performs other general and/or specific data processing for the system 100.

The repository 106 represents any type of storage device, such as computer memory devices or other tangible storage medium. The repository 106 represents one or more memory devices, located at one or more locations, and implemented as one or more technologies, depending on the particular implementation of the system 100.

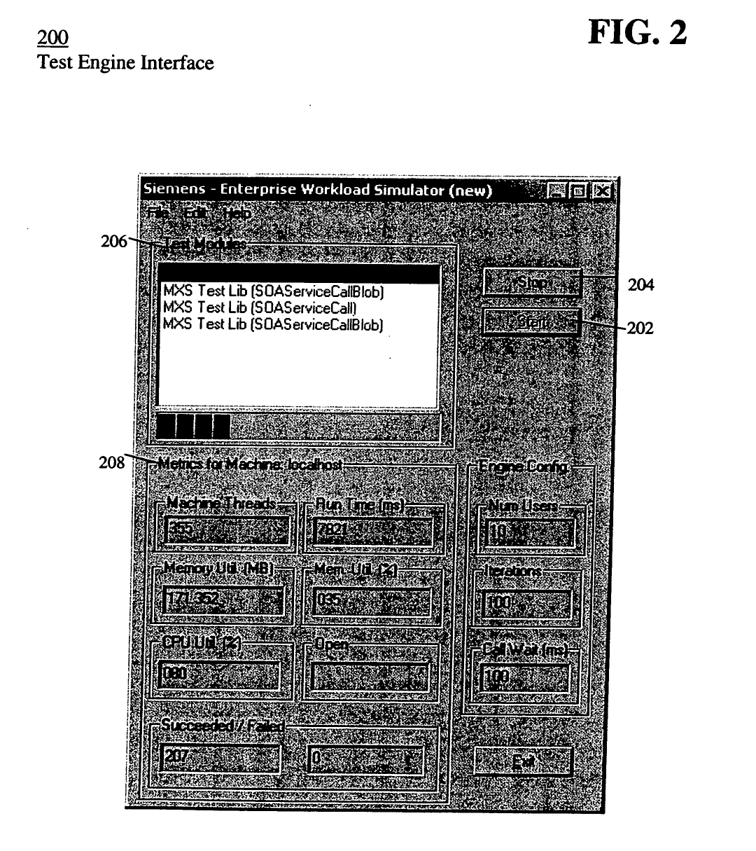

In the repository 106, the executable procedures 132 represent one or more processes that test (i.e., load, simulate usage, or stress) the target executable application 130. The executable procedures 132 operate in response to types of and values for the input parameters 134, the types of and range values 144 for the output data items 136, which are individually selectable and provided by the user 107, via the user interface 102, or by another device or system. The executable procedures 132 generate values for the output data items 136 in response to testing the target executable application 130. The log file 140 stores a record of activity of the executable procedures 132, including, for example, the types of and values for the input parameters 134 and the types of and range values 144 for the output data items 136, the values for the output data items 136. The processor 104 provides the data 142, representing display images 120, to the user interface 102 to be displayed by the display image 120 in the display 116. Examples of display images 120 generated by the display 116 include, for example, the display images 120 shown in FIGS. 2-8 and 13-24.

The remote system 108 may also provide the input parameters 134, receive the output data items 136 or the log file 140, and/or provide the predetermined thresholds 138. The target executable application 130 may be located in or associated with the remote system 130. Hence, the remote system 108 represents, for example, flexibility, diversity, and expandability of alternative configurations for the system 100.

An executable application, such as the target executable application 130 and/or the executable procedures 132, comprises machine code or machine readable instruction for implementing predetermined functions including, for example, those of an operating system, a software application program, a healthcare information system, or other information processing system, for example, in response user command or input. An executable procedure is a segment of code (i.e., machine readable instruction), sub-routine, or other distinct section of code or portion of an executable application for performing one or more particular processes, and may include performing operations on received input parameters (or in response to received input parameters) and providing resulting output parameters. A calling procedure is a procedure for enabling execution of another procedure in response to a received command or instruction. An object comprises a grouping of data and/or executable instructions or an executable procedure.

The system 100 tests the target executable application 130. The display processor 118 generates data 142, representing a display image 120, enabling the user 107 to select various test parameters. The test parameters include, for example: the types of and values for the input parameters 134 to be provided to the target executable application 130, and the types of and the associated expected range values 144 for the output data items 136 to be received from the target executable application 130. The test unit 122 provides one or more concurrently operating executable procedures 132 for interfacing with the target executable application 130. The executable procedures 132 provide the types and values for the input parameters 134 to the target executable application 130, and determine whether the values for the output data items 136 received from the target executable application 130 are within corresponding associated expected range values 144 for the output data items 136.

The executable procedures 132 simulate multiple users concurrently using the target executable application 130, thereby providing simulated user load or stress on the target executable application 130. The performance monitor 126 determines whether operational characteristics of the target executable application 130 are within acceptable predetermined thresholds 144. The operational characteristics include, for example, one or more of: a response time of the target executable application 130, processor 104 utilization by the target executable application 130, and memory 106 utilization by the target executable application 130.

The system 100 provides software quality assurance (SWA) band test software under load stress conditions over an extended time. The system 100 evaluates system foundation components and business logic classes of the target executable application 130 before the target executable application 130 is deployed to users. The system 100 has user-controlled flexible parameters to benchmark performance before deploying to prototype and beta customers. The system 100 eliminates inconsistencies in high performance and high volume stress testing. The system 100 allows developers to drill into the software code for the target executable application 130, without having to build a complicated test environment.

The system 100 provides a generic, plug-in environment offering repeatable testing. A plug-in (or plugin) is a computer program that interacts with another program to provide a certain, usually specific, function.

A main program (e.g., a test program or a web browser) provides a way for plug-ins to register themselves with the program, and a protocol by which data is exchanged with plug-ins. For example, open application programming interfaces (APIs) provide a set of definitions of the ways one piece of computer software communicates with another.

Plugins are typically implemented as shared libraries that need to be installed in a standard place where the application can find and access them. A library is a collection of computer subprograms used to develop computer software. Libraries are distinguished from executable applications in that they are not independent computer programs; rather, they are “helper” software code that provides services to some other independent program.

The system 100 builds plug-ins for testing of computer software (e.g., target executable application 130) in various situations. Testing is a process used to help identify the correctness, completeness, and quality of developed computer software. Testing includes, for example, stress testing, concurrency testing, regression testing, performance testing, and longevity testing. Other types of software testing may also be included.

Stress testing is a form of testing that is used to determine the stability of a given system or entity in response to a load. Stress testing involves testing beyond normal operational capacity (e.g., usage patterns), often to a breaking point, in order to test the system's response at unusually high or peak loads.

Stress testing a subset of load testing. Load testing generally refers to the practice of modeling the expected usage of a software program by simulating multiple users accessing the program's services concurrently. Load testing is most relevant for multi-user systems, often one built using a client/server model, such as web servers. There is a gray area between stress and load testing and no clear boundary exists when an activity ceases to be a load test and becomes a stress test.

Concurrency testing is concerned with the sharing of common resources between computations, which execute overlapped in time including running in parallel. Concurrency testing often entails finding reliable techniques for coordinating execution, exchanging data, allocating memory, detecting memory leak, testing throughput under a load, and scheduling processing time in such a way as to minimized response time and maximise throughput.

Regression testing is any type of software testing which seeks to uncover regression bugs. Regression bugs occur whenever software functionality that previously worked as desired stops working or no longer works in the same way that was previously planned. Typically regression bugs occur as an unintended consequence of program changes. Common methods of regression testing include re-running previously run tests and checking whether previously-fixed faults have reemerged. Regression testing allows for test suite definition, persistence, and subsequent regression testing.

Performance testing is software testing that is performed to determine how fast some aspect of a system performs under a particular workload. Performance testing can serve different purposes. Performance testing can demonstrate that the system meets performance criteria. Performance testing can compare two systems to find which performs better. Performance testing can measure what parts of the system or workload cause the system to perform badly.

Longevity testing measures a system's ability to run for a long time under various conditions. Longevity testing checks for memory leaks, for example. Generally, memory leaks are unnecessary memory consumption. Memory leaks are often thought of as failures to release unused memory by a computer program. A memory leak occurs when a computer program loses the ability to free the memory. A memory leak diminishes the performance of the computer, as it becomes unable to use its available memory.

The system 100 sends results of the testing to tabular files, for example, allowing for easy reporting using an Excel® program or any other commercial off the shelf (COTS) graphing program. The system 100 updates the user interface 102 in real-time with performance counters to determine if undesirable resource allocation or performance problems are occurring concurrent with testing. A flexible user interface 102 configures tests suites and test engine parameters. The system 100 executes and monitors the tests.

The system 100 reports success/failure statistics for tests that are run. For example, if a test is run overnight and two calls to the test method fail out of 100,000 calls, that information is captured on the user interface 102 and in the generated log file 140.

The system 100 targets a C++ programming language in a Microsoft environment, but may support other environments, such as Java.

The system 100 uses the Microsoft® component object model (COM) structure, for example, to provide a generic interface used by test authors to implement the process. COM-based test modules are auto-registered with the system 100, and are then self-discovered by a test engine, as shown in FIG. 2 and 9-11, to make the tests available in a suite configuration. The system 100 permits custom configuration of test suites and individual tests within the suite. However, other embodiments may use alternative structures. Such structures could utilize standard shared libraries (e.g., dynamic link libraries (DLLs) as a portable solution for testing native middleware modules. For example, the system 100 can be ported to Java to test Java middleware.

The plug-in approach allows software developers to write their own functional tests, exercising their software across multiple test parameters in a non-production environment that closely mirrors the variances found in a high volume production system. The software developers writing their own functional test need not be concerned with the associated complicated test code, embodied with in the test engine, needed to simulate multiple users, test performance, etc.

The system 100 provides methods for initialising, running, and tearing down tests. The system 100 allows for custom configuration of the test engine and of individual tests. The test executor controls the “configuration” of an individual test in a suite of tests to maximize the value of the testing process.

The system 100 provides the following advantages, for example. The system provides an extensible framework for testing system-level components in a Microsoft COM environment. The system 100 provides a framework for testing thread safety in components while not requiring component developers to implement a multi-threaded test program. The system 100 provides a reusable multi-threaded client to exercise system components. The system 100 provides configurable and persistent test suites including testing parameters. The system 100 provides a problem space to stress test software components. The system 100 provides persistent test suites allow for repeatable regression testing. The system 100 provides visualize performance though tight integration using the Microsoft performance monitor.

The system 100 implements the tests as standard in-process single-threaded apartment (STA) component object model (COM) objects. The figures shown herein provide a sample template along with instructions specifying how to implement a new test routine. Developers writing test modules do not have to work with the details of the COM structure; rather, they focus their time writing tests in C++ code. Test creators write C++ code and are shielded from COM specifics. Anything that can be written in C++ code can be tested. Some new tests can be created in less than two minutes. These objects serve as plug-ins for the performance test utility (i.e., test engine). By separating the test modules into stand-alone pieces of code, the core of the test engine does not need to be modified to build and execute a new test.

The “plug-in” approach provides a platform for domain owners and application groups to easily implement tests to meet their individual needs in a multi-threaded environment. Furthermore, the test engine utilizes the Performance Data Helper (PDH) API to track run-time metrics during execution. The PDH API is the foundation of Windows' Performance Monitor (PerfMon), represented by the performance monitor 126 (FIG. 1), and provides the entire scope of PerfMon functionality to developers working with the system 100.

The test engine, otherwise called a test processor, test system, or test method, provides the following basic capabilities. For a test, the test engine is configured to spawn a number of worker threads that execute the test routine. The number of threads, the total number of calls, and the frequency of the calls are configurable. The call frequency can also be set to random intervals, closely simulating true user behavior.

A thread in computer science is short for a thread of execution or a sequence of instructions. Multiple threads can be executed in parallel on many computer systems. Multithreading generally occurs by time slicing (e.g., where a single processor switches between different threads) or by multiprocessing (e.g., where threads are executed on separate processors). Threads are similar to processes, but differ in the way that they share resources.

A call is the action of bringing a computer program, subroutine (e.g., test routine), or variable into effect; usually by specifying the entry conditions and the entry point.

These capabilities permit the system 100 to tax system resources. For example, the system 100 may configure 100 threads to execute 10,000 calls per thread to a test routine. If the test routine is a service oriented architecture (SOA) call (i.e., a type of remote procedure call (RPC)), the test routine would result in 1,000,000 round trips to an application server and 1,000,000 executions of the SOA handler on that application server. In this scenario, a metrics gathering subsystem may be pointed to the application server to record system metrics on the distributed machine.

Having this type of test engine provides for flexible test scenarios. For example, an instance of the test engine can be run on several different machines hitting (i.e., applied to) a single application server. Tests can be set up to run for a long time (e.g., overnight or an entire weekend). The system 100 may also be used to replicate problems reported at customer sites.

The test engine records the following statistics in a log file 140 ten times, for example, for every test in a test suite (i.e., a collection or suite of tests). However, if the test contains few iterations, the number or times the information is logged is less than ten times. The recording frequency may be configurable, if such flexibility is desired. The test engine is capable of measuring PerfMon metrics on the machine of the user's choice (e.g., in an SOA environment the user can analyze the server).

The system 100 gathers the metrics, for example, shown in Table 1 below, through PerfMon, and can easily be expanded to include other metrics.

TABLE 1

| Metric | Description |
|---|---|
| Run Time | The amount of time the test has been running, measured |
| | using an internal clock, watch, or wall clock. |
| Machine | The amount of memory committed on the entire |
| Memory | computer. This is important to look at because many of |
| Usage | the tests will call code in other processes (e.g., like SOA |
| | handlers). By checking the committed memory on the |
| | entire computer, memory leaks can be identified. |
| Machine | The % of the total machine memory, including virtual |
| Memory % | memory, used on the computer. |
| Usage | |
| CPU % | The % utilization of the central processing unit (CPU), |
| Utilization | including both user and kernel time. |
| Machine | The total number of threads executing on the computer. |
| Threads | |
| Open . . . | Additional PerfMon counters may be easily added. |
| | Additionally, the tool may be enhanced to allow users to |
| | select their own counters. |
| Successes | The number of successful return codes received when |
| | calling the test routine. The success count is |
| | incremented for every call made to the test routine that |
| | returns an SMS return code of SMS_NO_ERROR. |
| Failures | The number of failures returned by calls to the test |
| | routine. Any SMS return code that is not |
| | SMS_NO_ERROR increments the fail count. |

FIG. 2 illustrates a user interface for the test engine 200 (i.e. a test engine interface) for the system 100, as shown in FIG. 1. The start button 202 begins the execution of the series of configured tests in the suite. The stop button 204 stops the execution of the series of configured tests in the suite.

The Test Modules block 206 shows a list of test modules included in the “current” test suite. The currently running test is highlighted. The highlighted tests progresses from top to bottom as the tests are performed. If the test suite is configured to loop around to perform the tests again, the highlighted item returns to the first test in the list, after the last test is completed. The system 100 provides the following advantages, for example.

The test interface allowing tests to be run within the testing engine.

The tests are registered on the test machine (i.e., test computer) permitting the administrator of the tests to see a catalog of available tests.

Test administrators may create groupings of tests (e.g., from those registered in the catalog) into persistent test suites. A test suite's configuration may be saved and restored for regression tests.

The test interface allows individual test to optionally expose test-specific user interfaces allowing the test administrator to custom configure the specific test.

Custom test configuration information and test engine configuration information are archived along with the test suite. A test suite includes a list of tests and the configuration information used by the test engine for the suite, and the configuration information for the individual tests in the suite.

The test engine can be modified to allow the testing administrator to collect information from any Windows performance monitor counter. The system also may be modified to allow the configurable selection, display, and capture, of existing performance monitor counters.

The “Metrics for Machine X” block 208 displays PerfMon metrics associated with the currently executing test. The screen metrics are updated every one third second,for example, and written to memory ten times per test, for example, but may be configurable by the user, if desired.

The test engine interface 200 includes the following menu structure. The File menu includes in vertical order from top to bottom: Open Test Suite, New Test Suite, Save Test Suite, and Save Test Suite As. The Edit menu includes in vertical order from top to bottom: Modify Test Suite and Logging Options. The menu options are described as follows.

The menus Open Test Suite and Save Test Suite permit user to open and save, respectively, test suites using standard windows File Open and File Save functions, respectively.

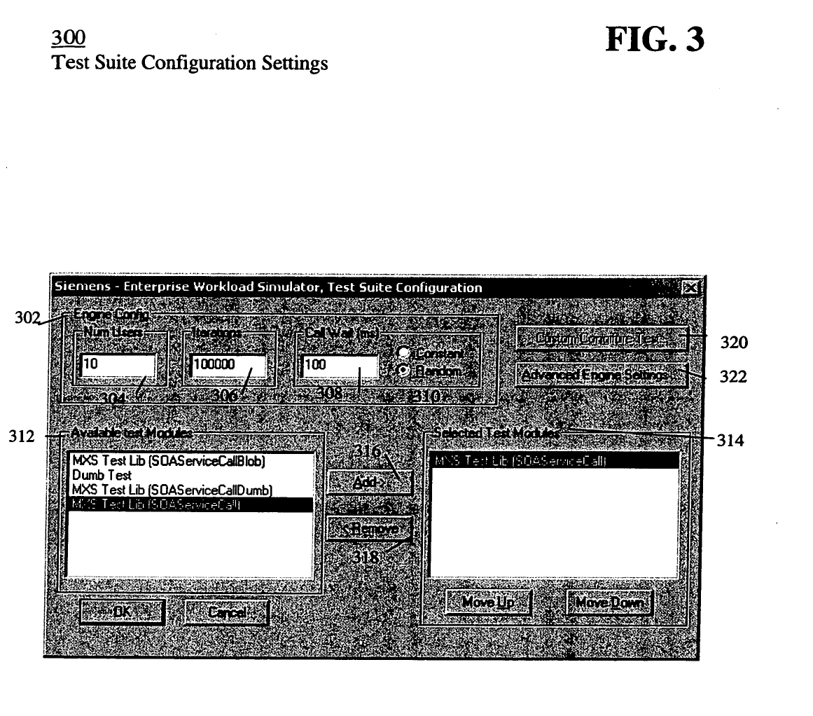

FIG. 3 illustrates test suite configuration settings for the test engine interface, as shown in FIG. 2. The system 100 displays FIG. 3 when the user selects, from the Edit menu in FIG. 2, the menu “Edit|Modify Test Suite” or “Edit|New Test Suite.” In FIG. 3, the “Engine Config.” area 302 lists the test configuration settings. These settings are specific for a test in the test suite. FIG. 3 includes the following features:

“Num Users” 304 is the number of users simulated by the system 100 (e.g., one user corresponds to one thread of execution).

“Iterations” 306 is the total number of calls made per thread.

“Call Wait (ms)” 308 is the wait time between individual calls, which can be set to zero for continuous execution.

“Constant/Random” 310 permits a test frequency to be selected by the user 107. If constant is selected, the system 100 waits the “Call Wait” time in milliseconds between individual calls. If random is selected, the system 100 waits a random time between zero and the “Call Wait” time in milliseconds between individual calls.

The “Available test Modules” area 312 lists the available tests on the machine, which are stored in the registry, and the “Selected Test Modules” area 314 displays those tests selected in the current test suite using the Add function 316 or the Remove function 318. The selected tests are executed in order during test suite execution.

The system 100 enables the “Custom Config Test” function 320 when the selected test module supports advanced custom configuration. The user 107 selects the function 320 to invoke the test's custom configuration capabilities. Individual tests may or may not support custom configuration. In other words, a developer may want his test to be configurable in some specific way. The test engine does not understand test-specific configuration types. However, by supporting a custom configuration interface, the test engine understands that the test supports custom configuration. Before test execution, configuration data captured by the test engine through the configuration interface is passed back to the test to allow it to configure itself accordingly. The custom configuration data is also stored in a test suite for regression testing purposes.

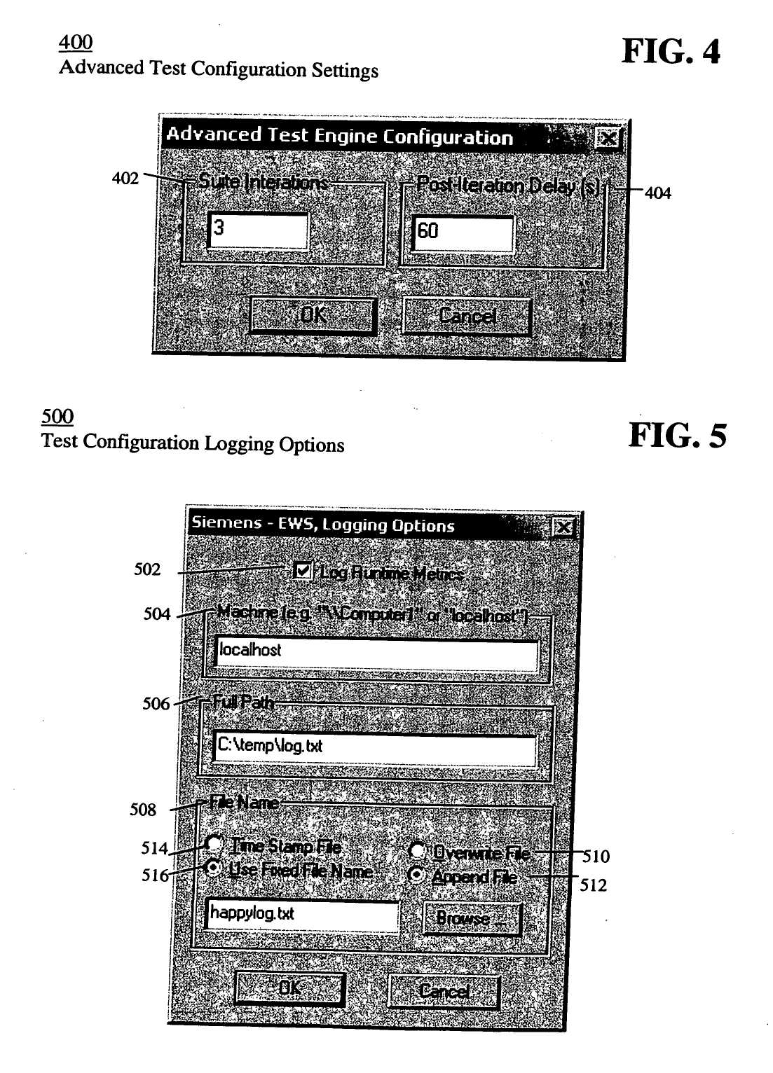

User selection of the “Advanced Engine Settings” function 322 displays the advanced test configuration settings 400, as shown in FIG. 4. In FIG. 4, a “Suite Iterations” function 402 permits the user 107 to input the total number of times (e.g., defaults to one) for the system 100 to execute a test suite. The “Post-Iteration Delay(s)” function 404 permits the user 107 to input the number of seconds that the system 100 waits between iteration of the suites. User input of the “Suite Iterations” function 402 to zero causes the test suite to run repeatedly until intervention by the user 107.

FIG. 5 illustrates test configuration logging options 500 for the test engine interface 200, as shown in FIG. 2. The system 100 displays the test configuration logging options 500 in response to user selection of the Edit menu “Edit|Logging Options,” as shown in FIG. 2.

The test configuration logging options 500 permits the user 107 to configure the test engine's logging options for the log file 140. The user may select a “Log Runtime Metric” function 502 to cause the system 100 to log the runtime metrics to the log file 140.

Under the “Machine” function 504, the user 107 is permitted to select the machine. The “Machine” function 504 points the metrics gathering subsystem (e.g., utilizing PerfMon) to machines other than itself. Connectivity is achieved through PerfMon, for example, which is capable of looking at distributed machines. The ability to capture metrics on a second machine is important, if the tests being executed include remote procedure calls to the second machine.

The user may specify the logging file path 506 and filename 508.

The user 107 may select that the results from a test may be overwritten to an existing file (i.e., select “Overwrite File” function 510) or appended to an existing file (i.e., select “Append File” function 512).

User selection of the “Time Stamp File” function 514 causes a test's log file to be written to a new file with a time-stamped filename. User selection of the “Use Fixed File Name” function 516 causes the system 100 to use a fixed file name.

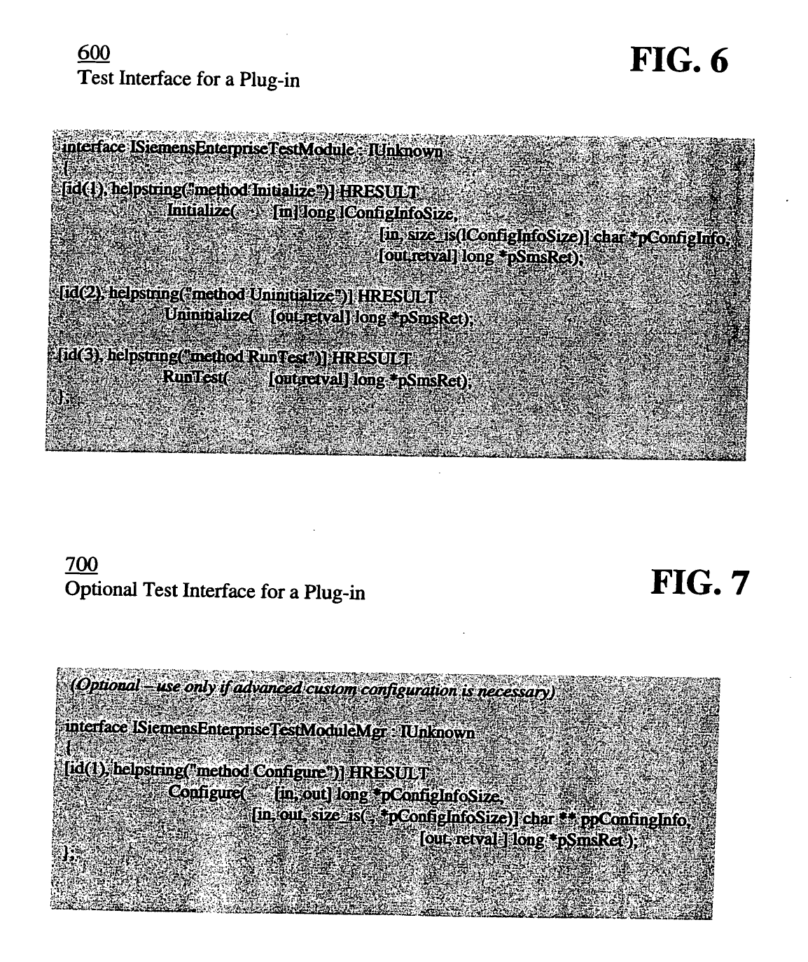

FIG. 6 illustrates a test interface for a plug-in 600. The test routines are implemented as standard in-process COM objects. Sample code and starting templates are available to developers to streamline the development of plug-ins.

The system 100 uses the test interface for a plug-in 600 on the COM object. Individual threads in the test engine calls the Initialize method before it calls the RunTest method. The pConfigInfo parameter is a pointer to configuration information for the test. The test module is prepared to receive Null for the pointer to this information. In this case, the test is performed with default settings. Any thread-specific initialization that is needed by the test is coded inside the Initialize method.

The null is a special value for a pointer (or other kind of reference) used to signify that the pointer intentionally does not have a target. Such pointer with null as its value is called a null pointer. For example, in implementations of the C language, a binary 0 (zero) is used as the null value, as most operating systems consider it an error to try to access such a low memory address.

The RunTest method calls the test code. The RunTest method is the routine at the center of the test. The RunTest method is called repeatedly based on how the engine is configured. The Initialized method is not called before individual calls to RunTest, it is called once before the first call to the RunTest Method.

Individual threads call the Uninitialized method before terminating.

FIG. 7 illustrates an optional test interface for a plug-in 700, which may be included in addition to the interface shown in FIG. 6. The Configure method is called in response to the Custom Configure Test function 320 (FIG. 3) being selected. If the system 100 does not include the optional test interface for a plug-in 700, the Custom Configure Test function 320 (FIG. 3) is grayed out, as shown in FIG. 3, when a test is selected under the Selected Test Modules function 314. In this case, the test module contains a hardwired test that cannot be configured.

Typically, this API causes the plug-in to display a dialog box allowing for the configuration of the test. The ppConfigInfo parameter contains the test specific configuration information when the call successfully returns. The test engine allocates memory for the configuration information. The test specific configuration information is later passed to the ISiemensEnterpriseTestModule: Initialize method, as shown in FIG. 6.

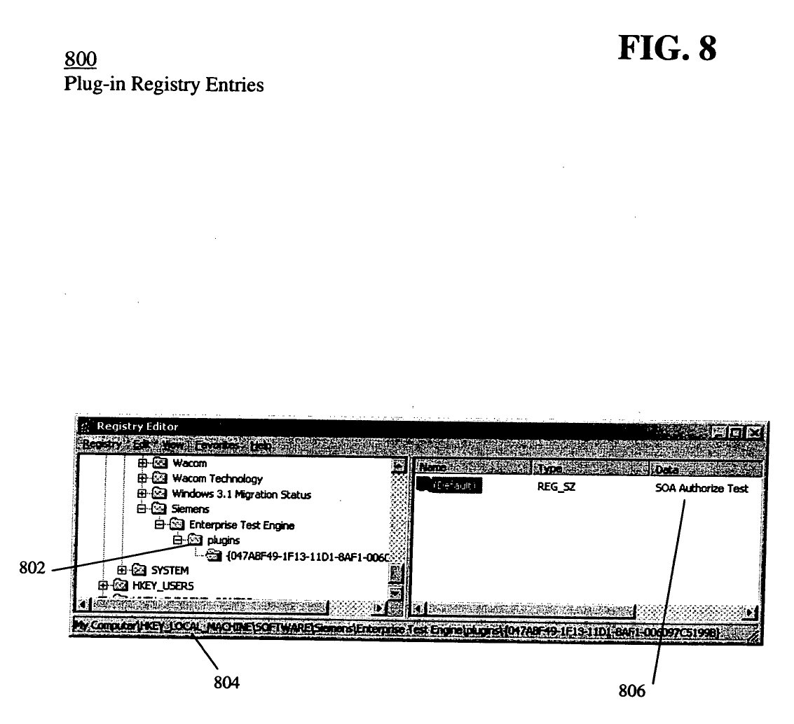

FIG. 8 illustrates plug-in registry entries 800. Test plug-ins are self-registering COM objects, using a standard windows utility, for example, called regsvr32.exe.

The plug-in sample is derived from an active template library (ATL) wizard in the Visual C++ Integrated Development Environment (IDE). The ATL is a set of template-based C++ classes that simplify the programming of COM objects. The COM support in Visual C++ allows developers to easily create a variety of COM objects. The wizard creates a script that automatically registers the COM object. Small modifications are needed to this script when converting the sample to a specific test module. The details of how to make these changes are provided herein.

In addition to the normal registry entries required for COM, a test engine plug-in needs to register itself below the following file, for example, \\HKLM\software\Siemens\Platform TestEngine\Plugins 802, as shown in FIG. 8.

Individual plug-ins create it's own node 804 under that file. The name of the node 804 is the object global unique identifier (GUID) for the COM object that provides the mentioned interfaces. The default value 806 for the node 804 includes a description for the plug-in that describes what the test performs.

The test engine interface 200 provides a Test Modules block 206 (FIG. 2) containing a list of the available tests. The test engine interface 200 provides the list by going to the above mentioned registry location and enumerating the nodes. The description of the plug-ins is used to populate the Test Modules block 206 (FIG. 2) with the list of the available tests.

When a user selects a test from the Test Modules block 206 (FIG. 2), the test engine uses the Win32 CoCreateInstance API with the GUID name of the plug-in key. The previously mentioned interfaces are expected to exist. If they are not found, an error is reported.

The snap-ins can use the area in the registry under their respective node to store state information, if they chose. Snap-ins are individual tools within a Microsoft Management Console (MMC). Snap-ins reside in a console; they do not run by themselves.

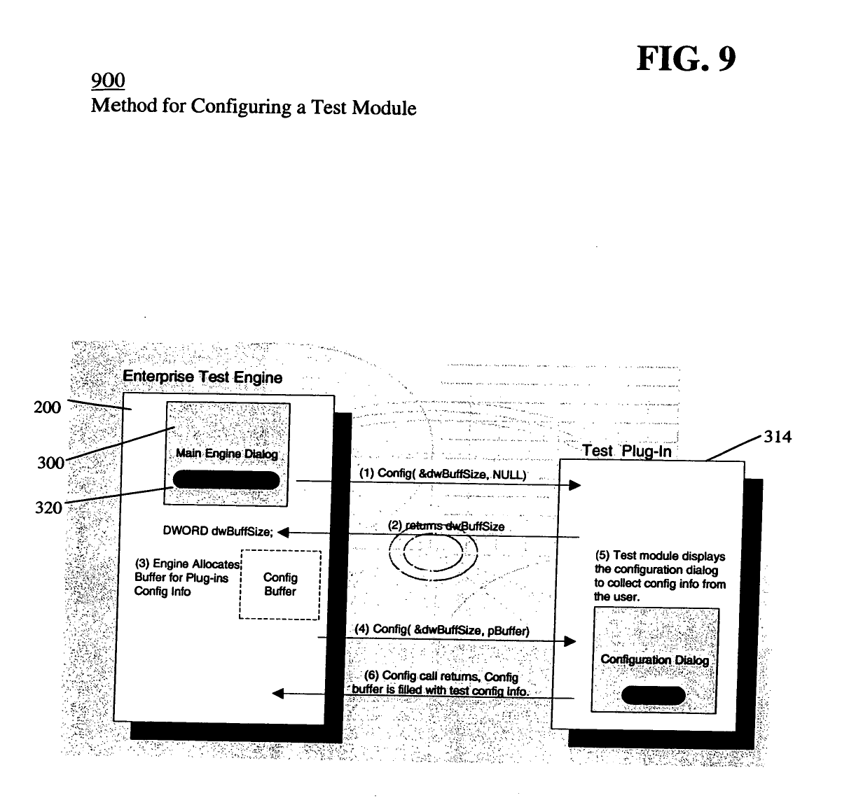

FIG. 9 illustrates a method 900 for a test engine interface 200 (FIG. 2) to configure a test module (i.e., a plug-in) 314 (FIG. 3). The method 900 describes how the system 100 drives the optional configuration of test modules, and how test configurations are stored for subsequent use.

Plug-in test modules 314 optionally include a custom configuration function 320 that allows test specific customization. For example, a test called “Authorize Test” might allow the configuration of the secured object or objects to make an authorize call. Without a configuration dialog, the test would need to be hard-coded. For a subsystem facility as complex as authorization, a hard-coded test module would provide minimal benefit, require a large amount of developer time to provide adequate coverage, and be difficult to maintain. Custom configuration permits test engineers to configure extensible tests, as required or desired.

The method 900 describes a five-step process for configuring a single test module.

At step one, the user 107 selects the “custom configure test” function 320 (FIG. 3) on the test engine interface 200, after selecting a test plug-in 314.

At step two, the test engine calls the Configure method (FIG. 7) on the plug-in, passing a Null for the configuration buffer pointer. This step causes the plug-in to return the needed size for the configuration information buffer.

At step three, the test engine allocates the needed space in the buffer (i.e., memory) and again calls the Configure method (FIG. 7) on the test plug-in 314, this time passing a pointer to the buffer.

At step four, the plug-in 314 displays a configuration dialog box inside the call. The dialog box is a modal window. In user interface design, a modal window (often called modal dialog) is a child window created by a parent application, usually a dialog box, which has to be closed before the user can continue to operate the application.

At step five, the user clicks OK on the dialog, the configuration buffer allocated by the test engine is filled with the configuration information. The test engine holds the buffer.

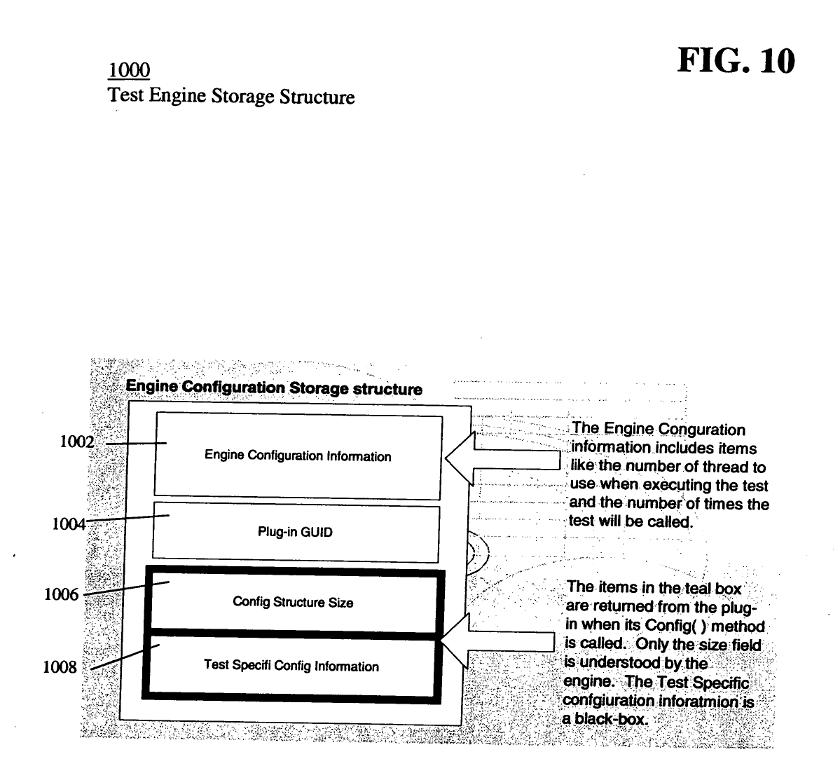

FIG. 10 illustrates a test engine storage structure 1000 describing how the test engine stores test configuration information for a test. The test engine maintains the configuration information for the tests that are part of a test suite. A test suite is made up of one or more test plug-ins and their configuration information.

The test engine configuration information 1002 includes items, such as the number of threads to use when executing the test, and the number of times the test will be called.

The configuration structure size 1006 and the test specific configuration information 1008 are returned from the plug-in when the Configuration method (FIG. 6) is called. The test engine understands the configuration structure size 1006.

The test-specific portion of the data is handled as a BLOB by the test engine. A BLOB is a binary large object that can hold a variable amount of data. The system 100 keeps a linked list of this structure when more than one plug-in is configured for use in a test suite. The linked list data members are not shown in FIG. 10.

The system 100 stores test configuration information. To persist configuration information, the system 100 saves the linked list of configuration information (FIG. 9) to memory (e.g., the repository 106, a disk, etc.). In time, additional higher-level configuration information might also be saved. Such configuration information may include whether the test suite is run once, continually, or scheduled.

The system 100 communicates configuration information to the plug-in. A pointer to the test-specific configuration information is passed to the plug-in in the ISiemensEnterpriseTestModule: Initialize method (FIG. 6). The system 100 calls this method is called for individual threads before the system 100 calls the actual test method, ISiemensEnterpriseTestModule: RunTest method (FIG. 6). The content of the configuration information is dictated by the plug-in.

The plug-in includes version information in the configuration data so that it can detect format changes to the data. Another approach would be to change the plug-in GUID 1004 for the test if the configuration data needs to change. This is the equivalent of creating a new test.

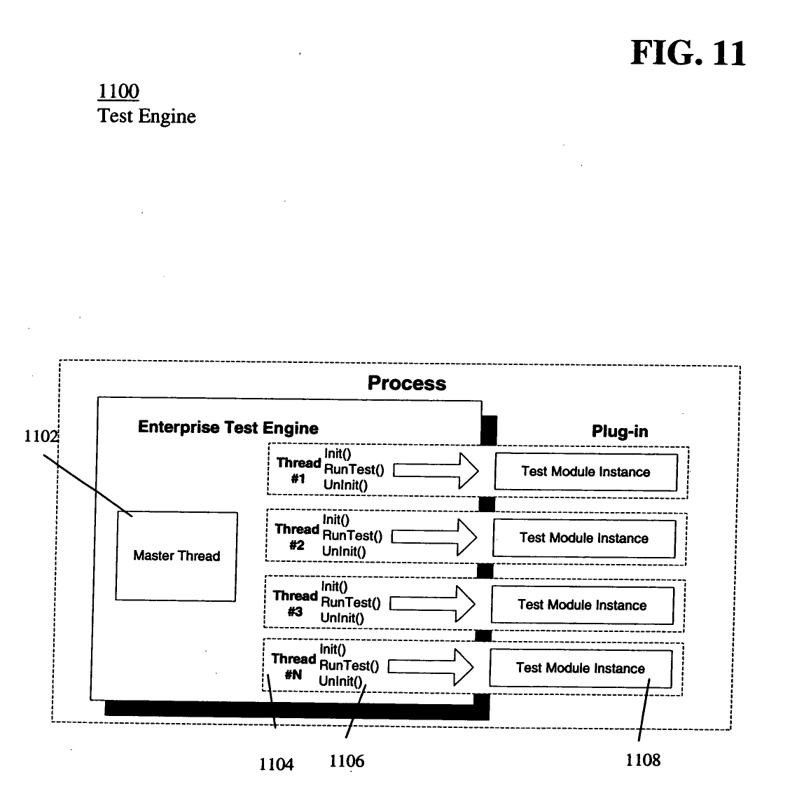

FIG. 11 illustrates a test engine 1100.

The master thread 1102 of the test engine is responsible for orchestrating a pool of worker threads (1-n) 1104, and coordinating interactions with the plug-ins 1108. The master thread 1102 is the default thread of the test engine process.

The master thread 1102 spins off a number of worker threads 1104 based on the information configured in the test engine interface. The worker threads 1104 individually call ISiemensEnterpriseTestModule: Initialize method (FIG. 6) before repeatedly calling the ISiemensEnterpriseTestModule: RunTest method (FIG. 6) on the plug-in instance 1108.

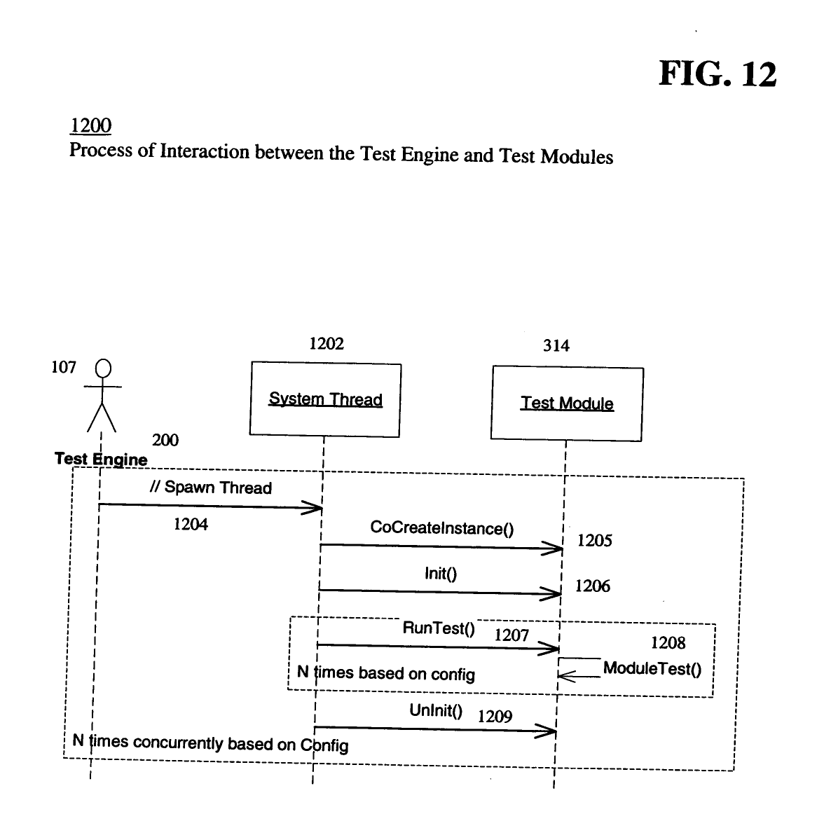

FIG. 12 illustrates a process 1200 (i.e., a sequence diagram of interaction between the test engine and the test modules. At step 1204, the test engine 200 creates a thread for individual simulated users. The number of threads is based on the configuration of the test engine. At step 1205, a thread loads the test module using the Win32 CoCreateInstance API. At step 1206, the thread calls the Initialize method (FIG. 6) on the tests framework interface. At step 1207, the thread repeatedly calls (e.g., n times based on the configuration) the tests RunTest method (FIG. 6), which performs the real test 1208, provided by the test module. A return value is evaluated and accounted for after individual calls (not shown). At step 1209, after the configured number of calls to the test module, individual thread calls the Uninitialize method (FIG. 6) of the test engine interface.

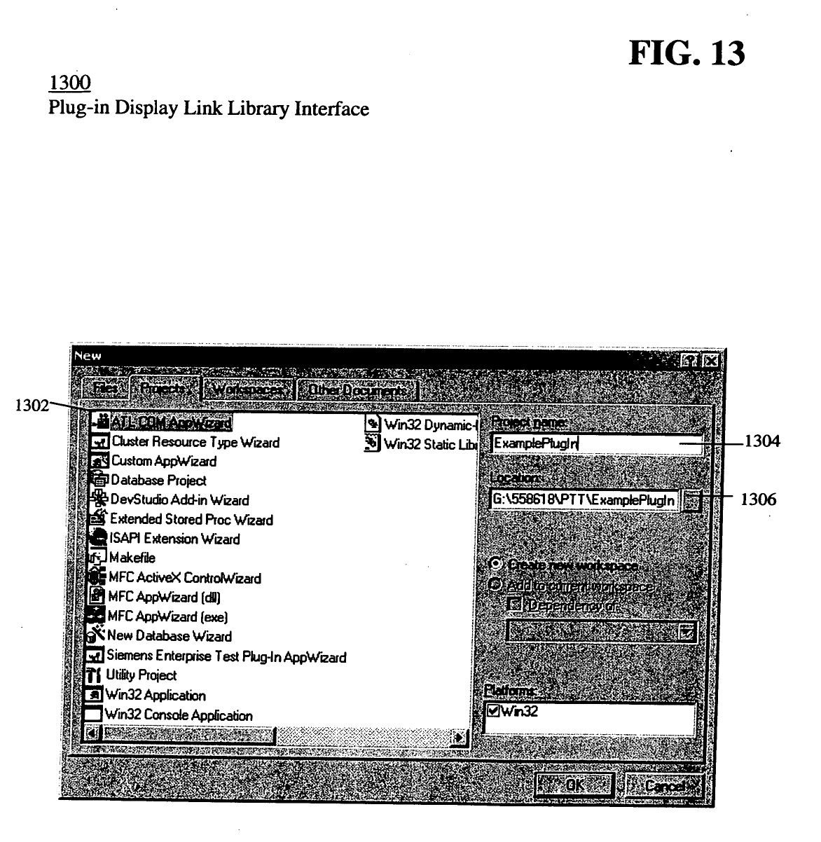

The remaining FIGS. 13-24 illustrate an example of steps on how to create a plug-in. The steps may be performed manually (e.g., by the user 107), automatically, or part manual and part automatic.

Multiple test plug-ins may be contained in a single DLL. These steps are performed when initially creating a plug-in DLL.

In FIG. 13, the system 100 displays a plug-in display link library interface 1300. The user 107 creates a new ATL COM project 1302 by entering the project name (e.g., Visual C++ IDE) 1304, and selects or enters where the plug-in code will reside (e.g., somewhere on the local memory) 1306.

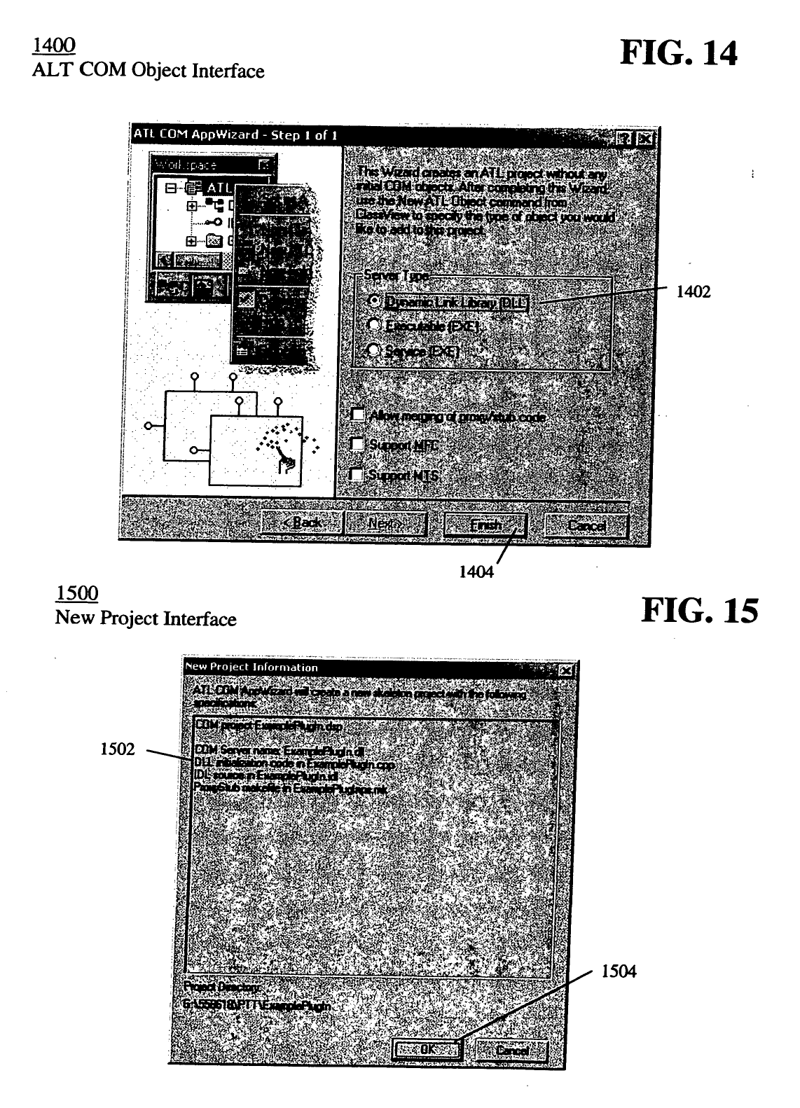

FIG. 14 illustrates a ALT COM object interface 1400. The user 107 accepts the selected defaults, as shown in FIG. 14, (e.g., DLL selected 1402) by selecting the “Finish” function 1404.

FIG. 15 illustrates a new project interface 1500. The ALT COM AppWizard creates a new skeleton project with the specifications 1502 shown in FIG. 15. The user 107 selects the “OK” function 1504 to build the project.

From the PTT (Plats Testing) domain (i.e., a storage location for software), the user 107 looks at the file EWSInterface.tlb. The user 107 registers the file, EWSInterface.tlb, on the system 100, using the following commands: project ptt 24.0; lookat ewsinterface.tlb; and regtlib ewsinterface.tlb. The user 107 has now finished creating a plug-in DLL, and is ready to create tests.

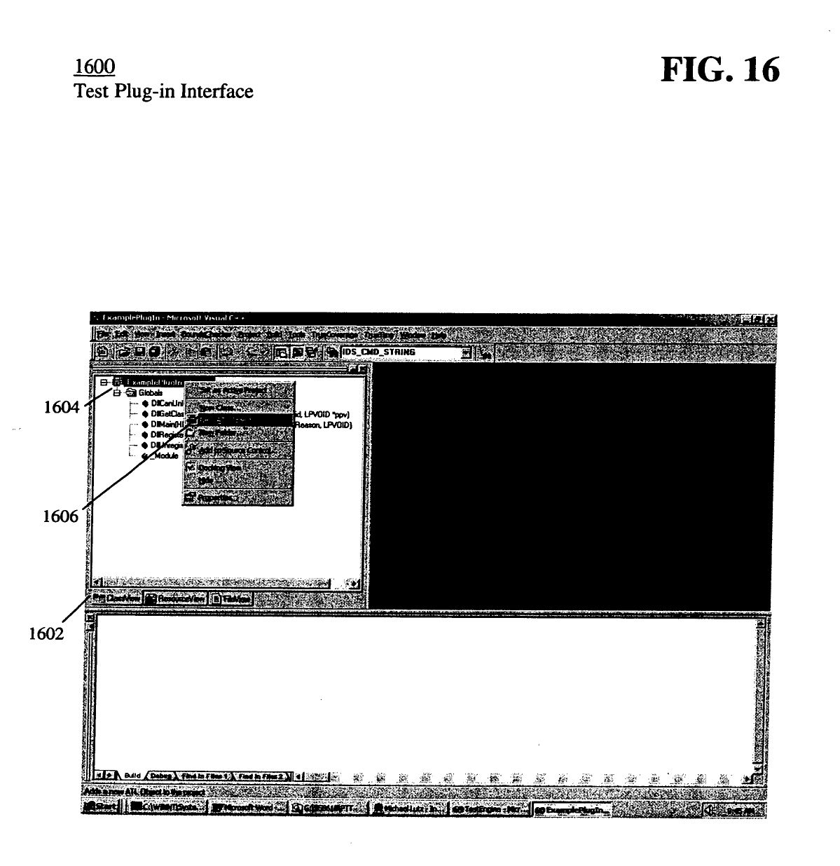

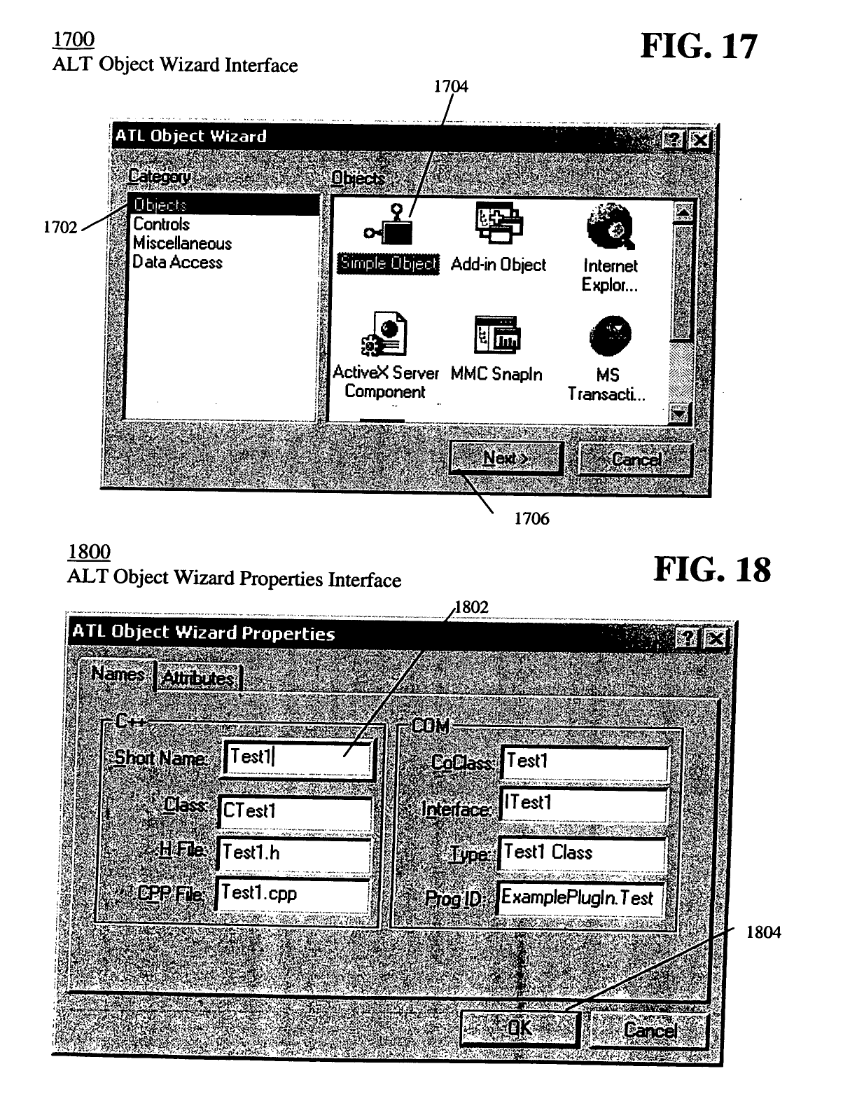

FIG. 16 illustrates a test plug-in interface 1600 to add a test. Individual tests contain a different COM object in the DLL. The user 107 uses an ATL Object to create a new DLL. The user navigates to a “Class View” tab 1602, and right clicks on the top entry (e.g., ExamplePlugIn) 1604 in the list. The user selects “New ATL Object” 1606 to cause the system 100 to display the ALT object wizard interface 1700, as shown in FIG. 17.

In FIG. 17, the user 107 selects the default selections (i.e., Category—Objects 1702, and Objects—Simple Object 1704), as shown in FIG. 17, by selecting the “Next” function 1706 to display the ALT object wizard properties interface, as shown in FIG. 18.

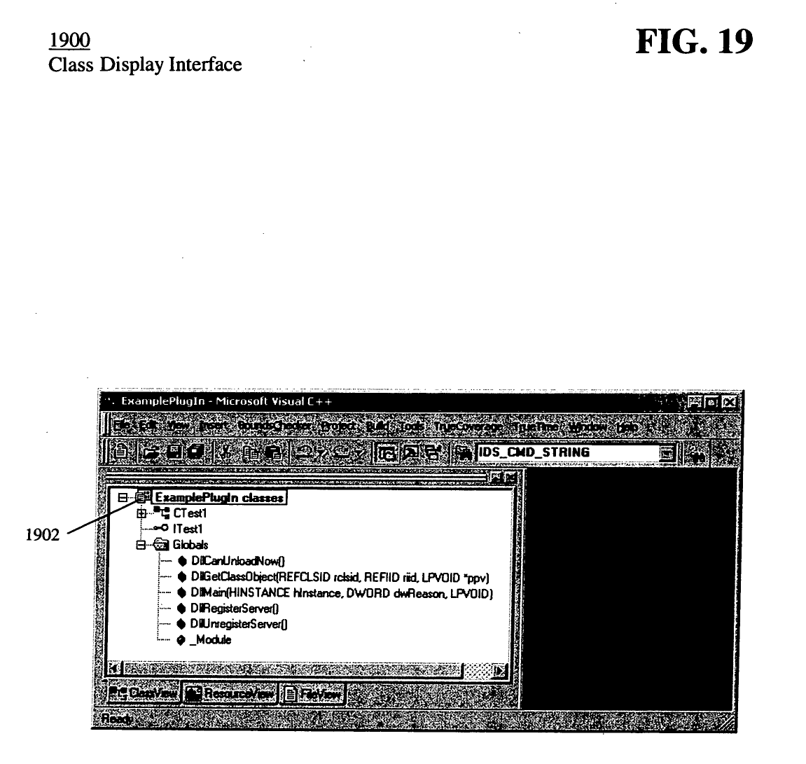

In FIG. 18, the user 107 types the name of the test 1802 and selects the “OK” function 1804 to display the class display (e.g., ExamplePlugin classes) 1902, as shown in FIG. 19.

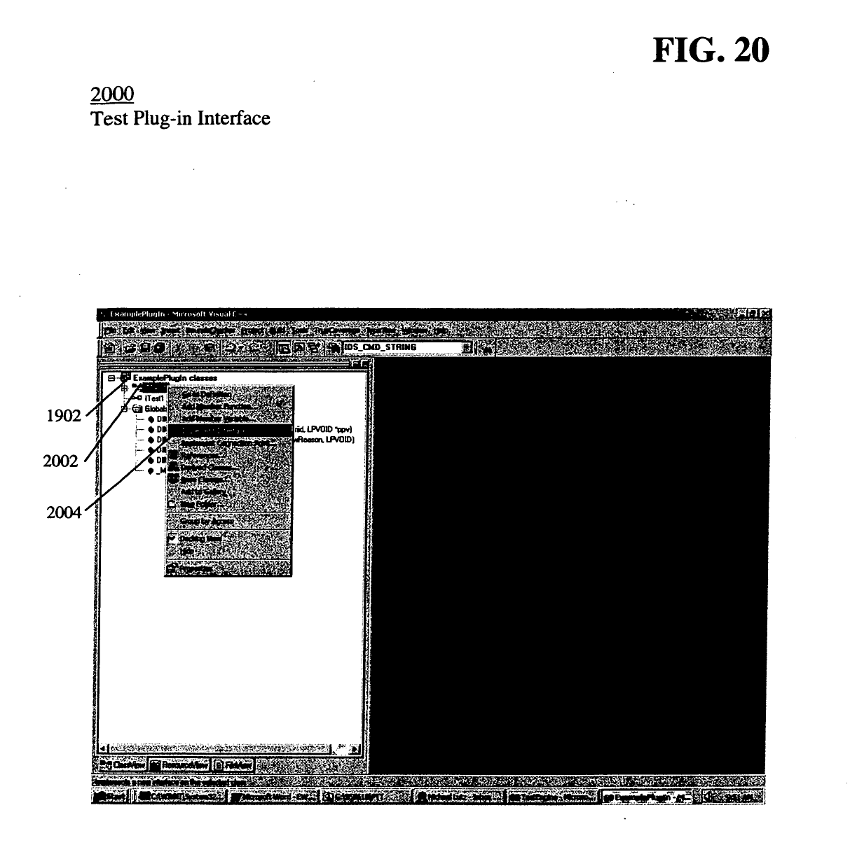

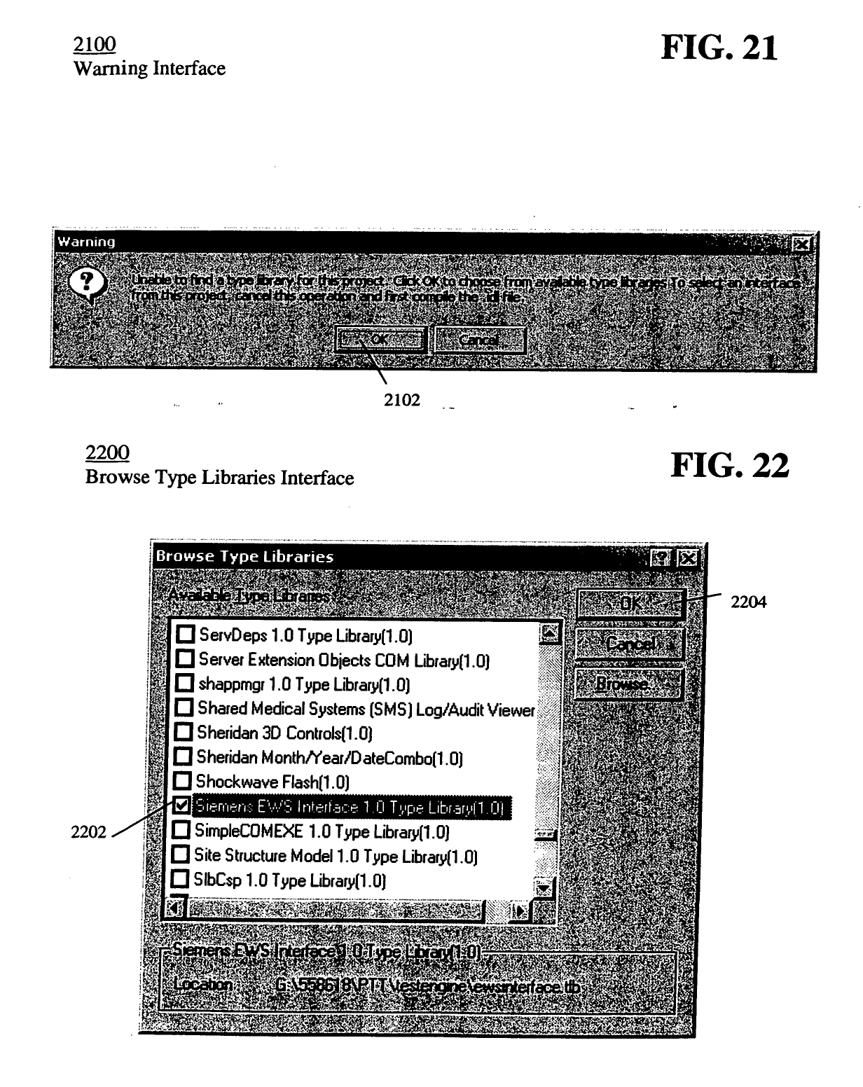

In FIG. 19 and 20, the user 107 implements the necessary interface(s) by right clicking on a newly created class (e.g., Test1) 2002, and choosing an “Implement Interface” function 2004 to cause the system 100 to display the warning interface 2100, as shown in FIG. 21.

In FIG. 21, the warning states: “Unable to find a type library for this project. Click OK to choose from available type libraries. To select an interface from this project, cancel this operation and first compile the idi file.” The user 107 selects the “OK” function 2102 to cause the system 100 to display the browse libraries interface 2200, as shown in FIG. 22.

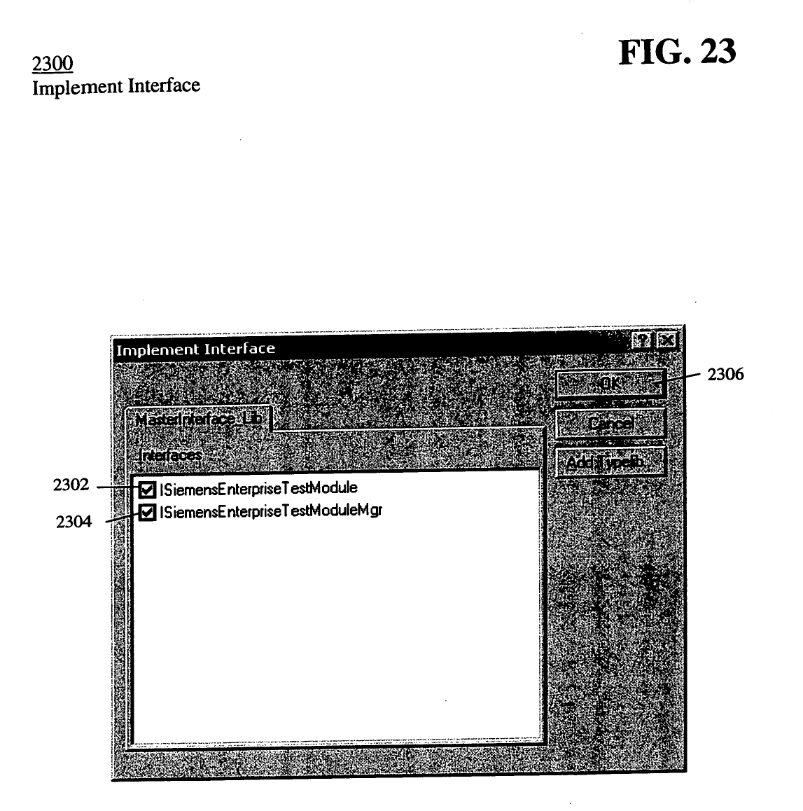

In FIG. 22, if the user 107 properly registered EWSInterface.tlb file on the system 100, as described herein above, the following item “Siemens EWS Interface 1.0 Type library (1.0)” 2202 appears in FIG. 22. The user 107 selects this item and clicks the “OK” function 2204 to cause the system 100 to display the implement interface 2300, as shown in FIG. 23.

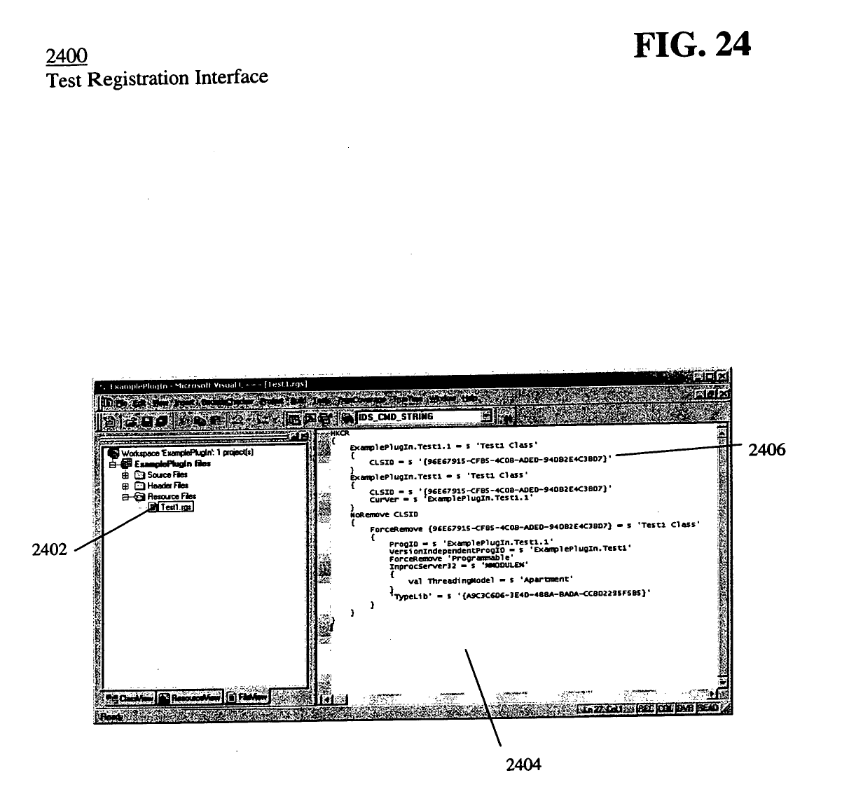

In FIG. 23, the user 107 has a decision to make. If the user 107 wants the specific test to support advanced custom configuration, the user selects both boxes (ISiemensEnterpriseTestModule 2302 and ISiemensEnterpriseTestModuleMgr 2304) as shown in FIG. 23. If not, the user 107 selects the first box (IsiemensEnterpriseTestModule) 2302 and not the second box (IsiemensEnterpriseTestNoduleMgr) 2304. After the user 107 makes the desired box selection(s), the user 107 selects the “OK” function 2306 to cause the system 100 to display the test registration interface 2400, as shown in FIG. 24.

In FIG. 24, the user 107 needs to add code for the proper registration of the test. The user 107 navigate to FileView, as shown in FIG. 24, and open the file xxx.rgs (e.g., Test1.rgs) 2402, where “xxx” is the name of the class created earlier in the process by the user 107. Opening the Test1.rgs file 2402 causes the system 100 to display the software code for the Test1.rgs file 2402 in the adjacent display window 2404.

Next, the user 107 copies the following code into the end of the Test1.rgs file 2402, shown in the window 2404 in FIG. 24. When copying the code below, the user replaces “%%%CLSID_Class%%%” in the code below with the first CLSID 2406 that the user sees in the user's version of the Test1.rgs file 2402, and replaces “%%%CLASS_NAME%%%” in the code below with the name of the class that the user created (e.g., Test1). This completes the set up process, and the user 107 is now ready to code his first plug-in.

HKLM
{

NoRemove Software
{

NoRemove ‘Siemens’
{

NoRemove ‘Enterprise Test Engine’
{

NoRemove ‘Plugins’
{

‘{%%%CLSID_CLASS%%%}’=s
‘%%%CLASS_NAME%%% Plug-

in’

}

}

}

}

}

The system 100 may be used to test user interfaces. The system 100 advantageously tests system components (e.g., middle-tier business objects and lower-level API's). For example, a developer may use the system 100 to stress test his software before the system's graphical user interface (GUI) has been constructed.

However, there are times where GUI code or components may require similar testing, particularly when looking for memory leaks. Even though environments like JavaScript have automatic “garbage-collection” of memory leaks, it is still possible to write “leaky code.”

A user 107 may write a generic test for the system 100 that is “custom configured” by being supplied a well-known universal resource locator (URL) that the test repeatedly opens. Placing the correct controls on this screen and pointing the metrics engine to “localhost” could identify leaks identified in the GUI. A limitation may be sending keystrokes through an Internet Explorer browser to the actual application. Hence, if a test can be conducted by just repeatedly opening a given URL, The system 100 provides a reasonable solution.

The system 100 itself is robust and without memory leaks. The system 100 was set to run twelve hours with in a test with fifty threads configured to execute with zero wait time between calls, thus the overall stress on the engine itself was maximized since the tests themselves did nothing.

No calls returned failure, nor did any COM errors occur, and the test was successful.

The internal stress test performed under the following configuration and characteristics.

50 threads

0 Wait time

1,000,000 calls per thread

The test engine was configured to repeat the test continuously.

The test returned a successful return code and did nothing else.

The internal stress test provided the following results.

| | |
|---|---|
| Test execution time: | About 12 hours |
| Total Transactions | 14 billion |
| Transactions per Second | 324,000 |
| Memory Leak Analysis | Memory usage remained constant. |
| CPU Utilization Analysis | CPU utilization remained constant (100%) |

The system advantageously supports quality assurance of a target software application 130, and measures performance to satisfy the following requirements.

Validate that software performs consistently over time.

Validate the absence of memory leaks.

Validate the absence of concurrency or timing issues in code.

Develop the throughput characteristics of software over time and under load.

Validate the robustness of business logic.

Hence, while the present invention has been described with reference to various illustrative examples thereof, it is not intended that the present invention be limited to these specific examples. Those skilled in the art will recognize that variations, modifications, and combinations of the disclosed subject matter can be made, without departing from the spirit and scope of the present invention, as set forth in the appended claims.

What is claimed is:

1. A system for testing an executable application, comprising:
a display processor for generating data representing a display image enabling a user to select,
input parameters to be provided to a target executable application; and
output data items to be received from the target executable application and associated expected range values of the output data items; and
a test unit providing a plurality of concurrently operating executable procedures for interfacing with the target executable application to provide the input parameters to the target executable application and to determine whether the output data items received from the target executable application are within corresponding associated expected range values of the output data items.

2. A system according to claim 1, wherein
the plurality of concurrently operating executable procedures simulate a plurality of users concurrently using the target executable application.

3. A system according to claim 1, further comprising:
a performance monitor for determining whether operational characteristics comprising at least one of, (a) response time, (b) processor utilization, and (c) memory utilization, of the target executable application are within acceptable predetermined thresholds.

4. A system according to claim 3, wherein the performance monitor further comprises:
a performance data helper (PDH) application programming interface (API).

5. A system according to claim 1, further comprising:
a log file for recording at least one of the following: input parameters, output data items, and expected range values.

6. A system according to claim 1, wherein the input parameters further comprise:
at least one of the following: a number of users simulated by the system, iterations providing a total number of calls per thread, call wait time between individual calls, and constant or random test frequency between individual calls.

7. A system according to claim 6, wherein the input parameters further comprise:
at least one of the following: a total number of times that the system performs a plurality of tests, and a time delay between completion of the plurality of tests.

8. A system according to claim 1, wherein the executable procedures further comprise a plug-in.

9. A system according to claim 8, wherein a plurality of plug-ins are stored in a dynamic link library (DLL).

10. A system according to claim 1, wherein the input parameters further comprise:
custom configuration settings associated with at least one particular executable procedure of the plurality of concurrently operating executable procedures.

11. A system according to claim 1, wherein the executable procedures further comprise: component object model (COM) objects.

12. A system according to claim 11, wherein the component object model (COM) objects are self-registering.

13. A system according to claim 1, wherein the plurality of concurrently operating executable procedures perform repeatable regression testing.

14. A method for testing an executable application, comprising the steps of:
providing a dynamic link library (DLL);
providing at least one plug-in, representing at least one executable procedure, for storage in the DLL;
providing at least one input parameter for the at least one plug-in; and
testing a target executable application in response to the plug-in.

15. A method according to claim 14 further comprising the steps of:
receiving at least one output data items from the target executable application.

16. A method according to claim 14 wherein the at least one plug-in simulates a plurality of users concurrently using the target executable application.

17. A method according to claim 14, wherein the input parameters further comprise:
at least one of the following: a number of users simulated by the system, iterations providing a total number of calls per thread, call wait time between individual calls, and constant or random test frequency between individual calls.

18. A method according to claim 17, wherein the input parameters further comprise:
at least one of the following: a total number of times that the system performs a plurality of tests, and a time delay between completion of the plurality of tests.

19. A method according to claim 14, wherein the input parameters further comprise:
custom configuration settings associated with at least one particular plug-in.

20. A method according to claim 14, wherein with the at least one plug-in further comprises: a component object model (COM) object.
